(19) United States
(12) Patent Application Publication
(10) Pub. No.: US 2014/0008172 A1
(43) Pub. Date: Jan. 9, 2014

(54) METHOD FOR OPERATING A HYDRAULIC DISC COUPLING IN AN AWD VEHICLE AND A COUPLING HEREFORE

(71) Applicant: Bo Lundstrom, Glumslov (SE)

(72) Inventor: Bo Lundstrom, Glumslov (SE)

(73) Assignee: BorgWarner Torq Transfer Systems AB, Landskrona (SE)

(21) Appl. No.: 14/003,250

(22) PCT Filed: Sep. 22, 2011
(86) PCT No.: PCT/SE2011/051135

§ 371 Date: Sep. 23, 2013

(30) Foreign Application Priority Data
Mar. 17, 2011 (SE) 1150238-2

(51) Int. Cl. F16D 13/72; F16D 13/74

(52) U.S. Cl. CPC F16D 13/72; F16D 13/74
USPC 192/70.12

(57) ABSTRACT

A hydraulic disc coupling (4) for an AWD vehicle is provided with an actuator pump (17) for actuating its disc package (12). There is a separate lubrication pump (30) for the purpose of both supplying lubricating and cooling oil to the disc package (12) at normal operating conditions and supporting the actuator pump (17) in quickly engaging the coupling (4) after its disconnection and possible emptying of lubricating and cooling oil.

### TECHNICAL FIELD

The present invention relates to a method of quickly engaging a disconnected, hydraulic disc coupling in an AWD vehicle and supplying its disc package with lubricating and cooling hydraulic oil, the disc coupling being actuated by a pump actuator system. It also relates to a coupling herefore.

### BACKGROUND OF THE INVENTION

As is well known in the art, an AWD (All Wheel Drive) vehicle can be provided with at least one hydraulic disc coupling for distributing the driving torque from the vehicle engine to all of the vehicle wheels. Especially, such a coupling may be provided in the drive line between the front axle and the wheels of the rear axle, most often in the vicinity of the rear axle differential.

Sometimes, it may be desirable to use the AWD vehicle in a FWD (Forward Wheel Drive) mode. In this case the coupling is disconnected, i e its discs are separated from each other. Also, the lubricating and cooling oil in the coupling housing may be allowed to be drained out in order to enhance the separation effect and minimize the rotational resistance of the coupling.

When the AWD mode is resumed, the coupling must resume its connected state very quickly, say within a period of 0.4-0.5 s. The coupling housing must also be refilled with lubricating and cooling oil.

### THE INVENTION

The present invention is concerned with a method of quickly engaging a disconnected, hydraulic disc coupling in an AWD vehicle and supplying its disc package with lubricating and cooling hydraulic oil, the disc coupling being actuated by a pump actuator system.

According to the invention, this method is characterized in that coupling engaging oil is supplied both by the pump of the pump actuator system and by a separate lubrication pump, also supplying lubricating and cooling oil to the disc package of the coupling.

The present invention is also concerned with a hydraulic disc coupling for an AWD vehicle provided with an actuator pump for actuating its disc package.

According to the invention, there is a separate lubrication pump for the purpose of both supplying lubricating and cooling oil to the disc package at normal operating conditions and supporting the actuator pump in quickly engaging the coupling after its disconnection and possible emptying of lubricating and cooling oil.

The lubrication pump is preferably connected to a hydraulic line from the actuator pump to a coupling actuation cylinder via a one-way valve.

The lubrication pump is preferably also connected to a housing of the coupling via a spring biased one-way valve, opening at a pressure of for example 0.5 bar.

In order to fulfill its function in assisting the coupling engagement, the lubrication pump can have a large displacement capacity in relation to the actuator pump, for example 2-3 times higher, but can deliver oil at a lower pressure.

The lubrication pump can be a gerotor pump.

### BRIEF DESCRIPTION OF THE DRAWINGS

The invention will be described in further detail below under reference to the accompanying drawings, in which

FIG. 1 is a schematic view of a first embodiment of a rear axle architecture with a disconnect coupling of an AWD vehicle,

FIG. 2 is a corresponding view of a second embodiment,

FIG. 3 shows a hydraulic scheme for the coupling according to the invention,

FIG. 4 is an isometric view of an example of a disconnect coupling according to the invention,

FIG. 5 is a sectional view through the coupling of FIG. 4,

FIG. 6 is section along the lines VI-VI in FIG. 5, and

FIG. 7 is an enlarged portion VII of FIG. 6.

### DETAILED DESCRIPTION

A drive system of an AWD (All Wheel Drive) vehicle is well known in the art. Typical examples are shown in WO 2011/043722. Such a system has an engine, a front axle with a differential, an intermediate shaft or cardan shaft, and a rear axle with a differential. In order to distribute the torque not only to the front axle but also to the rear axle in accordance with the driving conditions, an electronically controlled wet disc coupling is arranged in the driveline to the rear axle, often in the intermediate shaft or otherwise close to the rear differential. This wet disc coupling will be further described below.

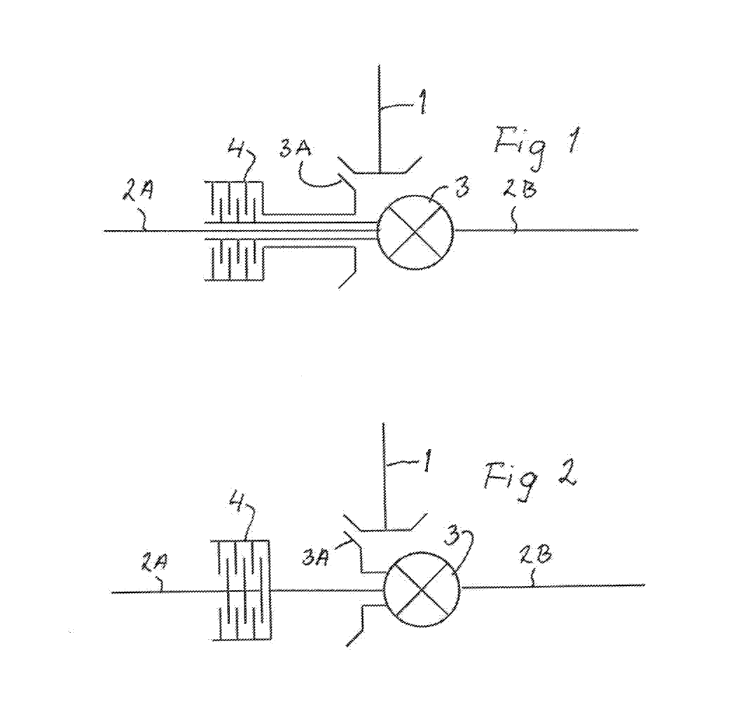

Two embodiments of rear axle architectures for an AWD vehicle are shown in FIGS. 1 and 2.

The first embodiment shown in FIG. 1 has the intermediate shaft 1, the rear axle 2 (axle halves 2A and 2B), the rear differential 3, and the wet disc coupling 4. The coupling 4 is arranged around the first rear axle half 2A functionally between a ring gear 3A and the housing of the differential 3.

The second embodiment shown in FIG. 2 contains the same members 1-4, but here the coupling 4 is situated in the first rear axle half 2A, providing the same result as the first embodiment.

The function of the coupling 4 when driving the vehicle in an AWD mode is described elsewhere, for example in the mentioned WO 2011/043722.

When it is desired to drive the AWD vehicle in an FWD (Forward Wheel Drive) mode, the disc coupling 4 is disconnected, i e its discs are separated for preventing them from transmitting any torque. In this mode the coupling 4 may be called a disconnect coupling. For enhancing this separation effect, the oil normally provided in the coupling 4 for lubricating and cooling its discs is allowed to be drained out from the coupling. In order to reduce the acceleration of the rotating mass of the intermediate propelling shaft 1 and to eliminate the drag torque in bearings and sealings therefore, means, preferably close to the front axle differential, may be provided to bring he intermediate shaft 1 to a standstill in FWD mode of the vehicle.

When the AWD mode of the vehicle is to be resumed, the requirement may be that the disc coupling 4 is fully operable within a time of 0.4-0.5 s, i e not only that the discs of the coupling are engaged but also that the coupling has been refilled with oil within this time.

The present invention is concerned with means for accomplishing this but also for normally providing the disc coupling 4 with oil for its cooling and lubricating.

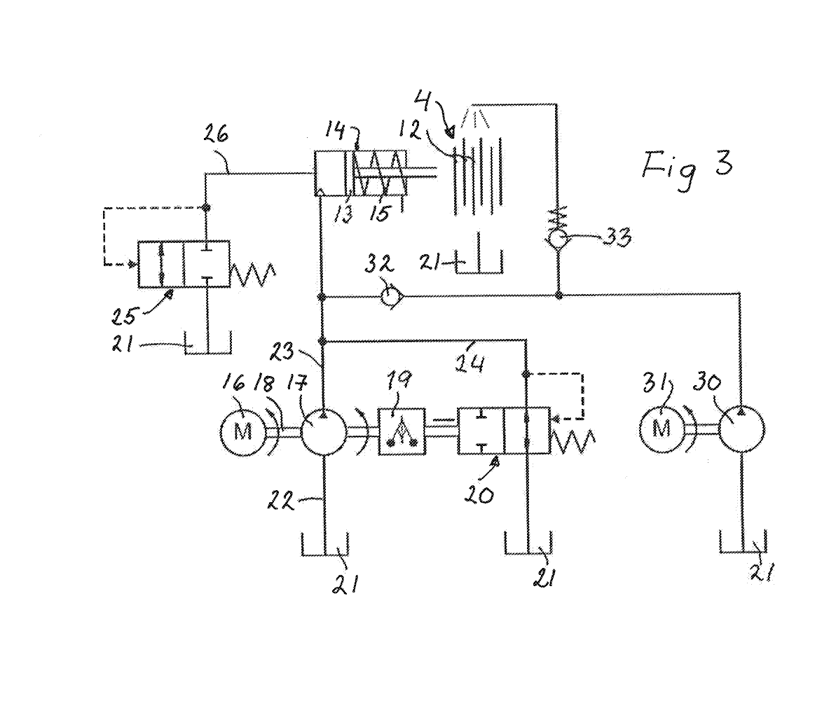

FIG. 3 is an overall illustration of the hydraulic means for actuating or controlling the disc coupling 4 and for accomplishing the objects of the invention. Reference is made to WO 2011/043722 for a full description of the actuating means.

The coupling 4 comprises a disc package 12 actuated by means of a piston 13 received in a cylinder 14. When the piston 13 is actuated by means of hydraulic pressure, the discs of the disc package 12 will get into contact with each other and establish driving contact between the two shafts to which they are connected. There is a return spring 15 of the compression type to bring the piston 13 back to its initial position, when the hydraulic pressure on the piston decreases.

An electric actuator motor 16 drives an actuator pump 17 via a drive shaft 18, which also drives a centrifugal regulator 19. The position of the centrifugal regulator 19 controls the position of and flow through a pressure overflow valve 20.

Hydraulic oil for the hydraulic actuator system is contained in a reservoir 21. It is sucked into the pump 17 through a hydraulic line 22 and is delivered therefrom towards the cylinder 14 through a hydraulic line 23. Depending on the position of the centrifugal regulator 19 and thus the pressure overflow valve 20, a portion of and sometimes all of the hydraulic flow is diverted through a hydraulic line 24, through the overflow valve 20 and back to the reservoir 21. The result is that the hydraulic actuator pressure delivered to the cylinder 14 is governed by the centrifugal regulator 19.

A relief valve 25 is connected to the cylinder 14 by means of a hydraulic line 26. The relief valve 25 has the purpose of diverting hydraulic oil from the cylinder 14 to the reservoir 21, when its pressure exceeds a certain level, for example 40 bar.

By the provision of the pressure overflow valve 20, creating an overflow of excess oil back into the reservoir 21, the actuator motor 16 may be constantly running and will hereby have a very short reaction time to build up pressure in the system when needed, as it is already running, and thus less energy will be spent for accelerating rotating parts.

Under normal operation conditions, when there is no need to have the coupling 4 engaged, the actuator motor 16 is running at a rotational speed below that at which the pressure overflow valve 20 closes: When there is a demand for engaging the coupling 4, i e for actuating the piston 13, a high current/voltage is supplied to the actuator motor 16. The speed of the drive shaft 18 will go up, whereby the overflow valve 20 will be closed by the centrifugal regulator 19. Conversely, if the rotational speed of the motor drive shaft 18 is lowered, the overflow valve 20 will be opened.

The function of the relief valve 25 is to control the maximum pressure in the system, to enable a calibration of the system at any time and to get rid of air in the system in connection with the assembly and also in connection with the starting of the vehicle engine.

This system may be called a pump actuator system, as opposed to an accumulator system. In this system the controlled actuator pressure is created and delivered by a pump, whereas in an accumulator system the controlled actuator pressure is delivered from an accumulator charged by a pump.

When the FWD mode for the vehicle is desired, the coupling 4 is disconnected by the return spring 15 in that the pressure in the cylinder 14 is decreased. At the same time the coupling housing is opened to the oil reservoir 21, so that the oil therein is drained out and the possible drag effect thereof is eliminated.

As already stated, the operational condition of the coupling 4 shall be resumed very quickly after a disconnection as described, say within 0.4-0.5 s. This means that the coupling 4 shall be fully engaged and the coupling housing filled with lubricating and cooling oil.

According to the invention this is accomplished by a separate lubrication pump 30 driven by an electric lubrication motor 31 and sucking oil from the reservoir 21. The lubrication pump 21 preferably has a large displacement capacity (say 2-3 times the displacement of the pump 17) but only needs to deliver a limited pressure. It may for example be of the gerotor type.

The lubrication pump 30 is connected to the hydraulic line 23 (to the cylinder 14) via a one-way valve 32 as well as to the housing of the coupling 4 via a spring biased one-way valve 33 opening at a pressure of say 0.5 bar.

When the disconnect mode of the coupling 4 is to be abandoned (FWD) and normal operation conditions resumed (AWD), the two motors 16 and 31 are started, and the lubrication pump 30 driven by the latter one and having a large displacement will assist in quickly filling the cylinder 14 and compress the return spring 15 for engaging the discs 12, until the one-way valve 32 closes. At the pressure set by the one-way valve 33 lubricating oil will start to be delivered to the discs 12 of the coupling 4.

When the normal operation conditions have been resumed, the one-way valve 32 is closed, so that the lubrication pump 30 only delivers lubricating and cooling oil to the housing of the coupling 4.

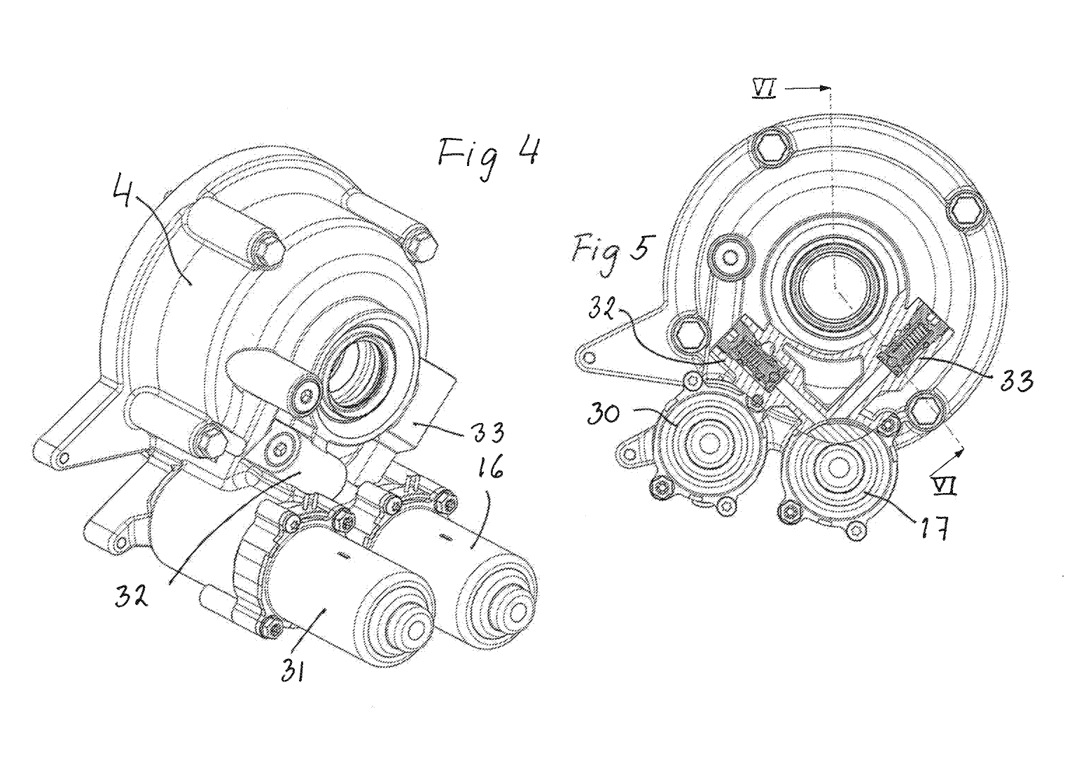

FIG. 4 is an isometric view of a practical embodiment of a disconnect coupling according to the invention. Shown therein is generally speaking the housing containing the wet disc or disconnect coupling 4, the electric actuator motor 16, the electric lubrication motor 31, and the two one-way valves 32 and 33.

In the section of FIG. 5, the actuator pump 17, the lubrication pump 30, and the two one-way valves 32 and 33 are enumerated.

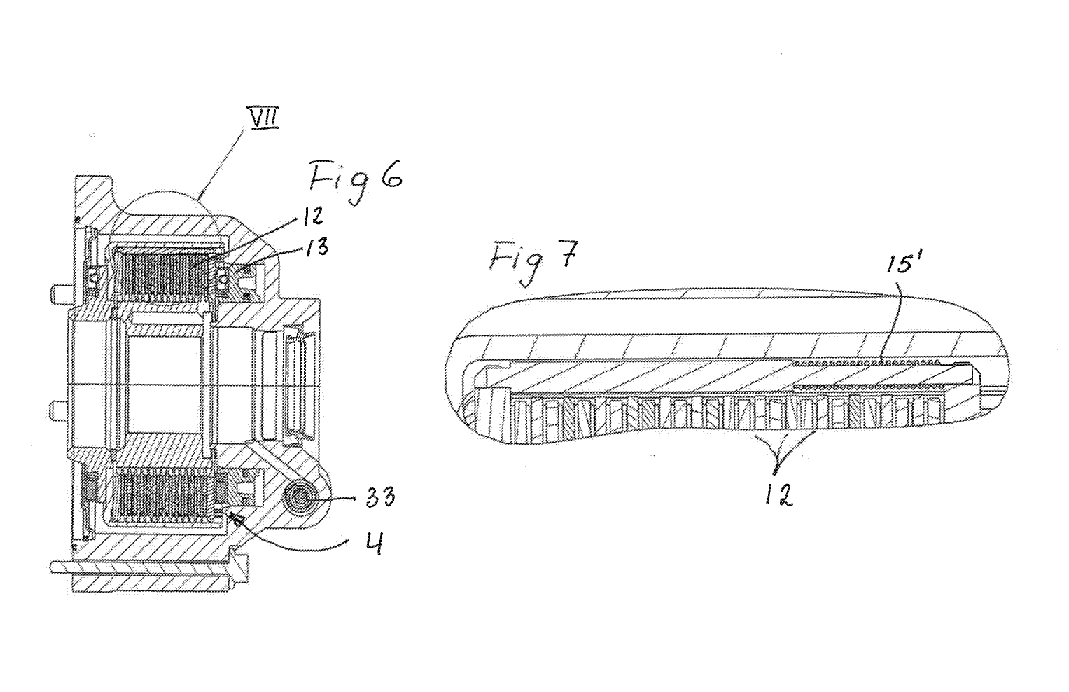

In the section of FIG. 6, the disc package 12 and the actuator piston 13 of the coupling 4 as well as the one-way valve 33 are shown.

In the hydraulic scheme in FIG. 3 there is shown a return spring 15 for the actuator piston 13. However, in the practical embodiment shown in FIGS. 4-7 there is instead—as indicated in FIG. 7—a number of return springs 15′ around the disc package 12 pushing its discs apart and thus also acting on the piston 13 in its return direction.

Modifications are possible within the scope of the appended claims.

1. A method of quickly engaging a disconnected, hydraulic disc coupling in an AWD vehicle and supplying its disc package with lubricating and cooling hydraulic oil, the disc coupling being actuated by a pump actuator system, comprising coupling engaging oil supplied both by the pump of the pump actuator system and by a separate lubrication pump, supplying lubricating and cooling oil to the disc package of the coupling.

2. A hydraulic disc coupling for an AWD vehicle provided with an actuator pump for actuating its disc package, comprising a separate lubrication pump for the purpose of both supplying lubricating and cooling oil to the disc package at normal operating conditions and supporting the actuator pump and quickly engaging the coupling after its disconnection.

3. A hydraulic disc coupling according to claim 2, wherein the lubrication pump is connected to a hydraulic line from the actuator pump to a coupling actuation cylinder via a one-way valve.

4. A hydraulic disc coupling according to claim 2, wherein the lubrication pump is connected to a housing of the coupling via a spring biased one-way valve, opening at a pressure of for example 0.5 bar.

5. A hydraulic disc coupling according to claim 2, wherein the lubrication pump has a large displacement capacity in relation to the actuator pump.

6. A hydraulic disc coupling according to claim 5, wherein the lubrication pump is a gerotor pump.
